(19) United States
(12) Patent Application Publication
(10) Pub. No.: US 2026/0187579 A1
(43) Pub. Date: Jul. 2, 2026

(54) Video Surveillance System and Methods for Tracking Vehicles Including Trailers

(71) Applicant: Eagle Eye Networks, Inc., Austin, TX (US)

(72) Inventors: Hari Surendranath, Bangalore (IN); Navaneethan Sundaramoorthy, Peelamedu (IN); Sankaranarayanan Parameswaran, Bangalore (IN); Dossan George, Thrissur (IN)

(73) Assignee: Eagle Eye Networks, Inc., Austin, TX (US)

(21) Appl. No.: 19/003,014

(22) Filed: Dec. 27, 2024

(51) Int. Cl. G06Q 10/0833; G06V 20/40; G06V 20/52; G06V 20/62

(52) U.S. Cl. CPC G06Q 10/0833; G06V 20/40; G06V 20/52; G06V 20/625; G06V 2201/08

(57) ABSTRACT

When a vehicle enters an access point at a facility, a first video stream of the vehicle may be analyzed to determine whether the vehicle is a tractor. If so, embodiments may analyze one or more additional video streams of the vehicle from other angles to capture tractor information and determine whether the tractor is connected to a trailer. If the tractor is connected to a trailer, embodiments may capture a video stream of the trailer to get trailer information. Embodiments may use this information to determine a cargo associated with the vehicle to confirm delivery and/or provide better routing for the vehicle and/or cargo.

### BACKGROUND

### Field of the Disclosure

This disclosure relates generally to video surveillance systems and more particularly to systems for tracking vehicles including tractor units with trailers.

### Description of the Related Art

Semi-trailer trucks (also referred to as “semis” or “trucks”) may refer to a combination of a tractor unit (a tractor) and one or more trailer units (trailers) used to transport large quantities of goods (e.g., from a manufacturer to a retail location, from the manufacturer to a warehouse, from a warehouse to a retail location, etc.). A tractor may couple to a first trailer at an originating location, decouple from the first trailer and couple to a second trailer at a first stop, decouple from the second trailer and couple to a third trailer at a second stop, and so on. Furthermore, traveling may require a truck to cover long distances, which may involve traffic. As a result, when a truck arrives at a destination, the truck may be solo (e.g., a tractor but no trailers) or coupled to one or more trailers. Furthermore, a tractor and trailer combination might not be commonly-owned (e.g., the tractor may be owned by a first entity and the trailer might be owned by a second entity).

A warehouse may be expecting a shipment via a truck but might not know exactly when the truck is going to arrive or when it arrives.

### SUMMARY

Embodiments allow a warehouse to identify vehicles arriving at the location to identify trucks, identify a tractor of a semi-trailer, determine an entity associated with the tractor, identify a trailer of the semi-trailer and determine an entity associated with the trailer.

Embodiments may be directed to a method for vehicle identification and cargo tracking. The method may comprise, at a bridge associated with a location: receiving a first video stream containing a first plurality of images of a vehicle entering an access point associated with the location; determining a vehicle signature for the vehicle entering the access point; determining that the vehicle entering the access point comprises a tractor entering the access point; receiving a second video stream, wherein the second video stream contains a second plurality of images of the tractor entering the access point; determining tractor registration information for the tractor entering the access point from the second video stream; and communicating the vehicle signature and the tractor registration information for the tractor entering the access point to a data center. The method may also comprise a date center performing: receiving the vehicle signature and the tractor registration information for the tractor entering the access point; adding the tractor to a census of tractors located at the location; determining a transportation entity associated with the tractor; and determining a cargo associated with the transportation entity.

In some embodiments, the first video stream is received from a first camera oriented to capture the first video stream relative to a front of the vehicle entering the access point. In some embodiments, the second video stream is received from a second camera oriented to capture the second video stream relative to a side of the tractor entering the access point. In some embodiments, the second camera is oriented to capture the second video stream relative to a door of the tractor entering the access point. In some embodiments, the tractor registration information comprises a Department of Transportation (DOT) number.

In some embodiments, the method further comprises, at the bridge: receiving a third video stream containing a plurality of images of the tractor entering the access point; determining the tractor entering the access point is connected to a trailer; determining a first trailer signature for the first trailer; determining first trailer license plate information from a license plate on the first trailer; and communicating the first trailer signature and the first trailer license plate information to the data center. In some embodiments, the method further comprises the data center performing: receiving the first trailer signature and the first trailer license plate information; adding the first trailer to a census of trailers located at the location; determining a cargo entity associated with the first trailer; and determining a cargo associated with the cargo entity.

In some embodiments, the method further comprises, at the bridge: receiving a fourth video stream containing a plurality of images of a vehicle exiting the access point; determining a vehicle signature for the vehicle exiting the access point; determining, based on the vehicle signature, that the vehicle exiting the access point comprises a tractor; determining tractor registration information for the tractor exiting the access point; and communicating one or more of the tractor signature and the tractor registration information for the tractor exiting the access point to the data center. In some embodiments, the method further comprises the data center performing: receiving one or more of the tractor signature and the tractor registration information for the tractor exiting the access point; and removing the tractor exiting the access point from the census of tractors located at the location.

In some embodiments, the method further comprises, at the bridge: receiving a fifth video stream containing a plurality of images of a second trailer connected to the tractor exiting the access point; determining a second trailer signature for the second trailer; and determining second trailer license plate information from a license plate on the second trailer; and communicating one or more of the second trailer signature and the second trailer license plate information to the data center. In some embodiments, the method further comprises the data center performing: receiving the second trailer signature and the second trailer license plate information; and removing the second trailer from the census of trailers located at the location.

In some embodiments, the method further comprises determining tractor license plate information from a license plate on the truck entering the access point, wherein determining that the vehicle entering the access point comprises a tractor entering the access point is based on one or more of the vehicle signature and the tractor license plate information. In some embodiments, the method further comprises determining tractor license plate information from a license plate on the truck exiting the access point, wherein determining that the vehicle exiting the access point comprises a tractor entering the access point is based on one or more of the vehicle signature and the tractor license plate information.

Some embodiments may be directed to a system for vehicle identification and cargo tracking. The system may comprise a bridge communicatively coupled to a plurality of cameras associated with a location and a data center having a plurality of servers. The bridge comprises abridge memory storing a set of bridge instructions; and a bridge processor configured to execute the set of bridge instructions to: receive a first video stream containing a first plurality of images of a vehicle entering an access point associated with the location; determine a vehicle signature for the vehicle entering the access point; determine that the vehicle entering the access point comprises a tractor entering the access point; receive a second video stream, wherein the second video stream contains a second plurality of images of the tractor entering the access point; and determine tractor registration information for the tractor entering the access point from the second video stream. Each server comprises a server memory storing a set of server instructions and a server processor configured to execute the set of server instructions to: communicate with the bridge to receive the tractor registration information for the tractor entering the access point, the first video stream and the second video stream; add the tractor to a census of tractors located at the location; determine a transportation entity associated with the tractor; and determine a cargo associated with the transportation entity.

In some embodiments, the first video stream is received from a first camera oriented to capture the first video stream relative to a front of the vehicle entering the access point. In some embodiments, the second video stream is received from a second camera oriented to capture the second video stream relative to a side of the tractor entering the access point. In some embodiments, the second camera is oriented to capture the second video stream relative to a door of the tractor entering the access point. In some embodiments, the tractor registration information comprises a Department of Transportation (DOT) number.

In some embodiments, the bridge processor is further configured to: receive a third video stream containing a plurality of images of the tractor entering the access point; determine the tractor entering the access point is connected to a trailer; determine a first trailer signature for the first trailer; determine first trailer license plate information from a license plate on the first trailer; communicate the first trailer signature and the first trailer license plate information to the data center. In some embodiments, the data center processor is further configured to: receive the first trailer signature and the first trailer license plate information; add the first trailer to a census of trailers located at the location; determine a cargo entity associated with the first trailer; and determine a cargo associated with the cargo entity.

In some embodiments, the bridge processor is further configured to: receive a fourth video stream containing a plurality of images of a vehicle exiting the access point; determine a vehicle signature for the vehicle exiting the access point; determine, based on the vehicle signature, that the vehicle exiting the access point comprises a tractor; determine tractor registration information for the tractor exiting the access point; and communicate one or more of the tractor signature and the tractor registration information for the tractor exiting the access point to the data center. In some embodiments, the data center processor is further configured to: receive one or more of the tractor signature and the tractor registration information for the tractor exiting the access point; and remove the tractor exiting the access point from the census of tractors located at the location.

In some embodiments, the bridge processor is further configured to: receive a fifth video stream containing a plurality of images of a second trailer connected to the tractor exiting the access point; determine a second trailer signature for the second trailer; and determine second trailer license plate information from a license plate on the second trailer; and communicate one or more of the second trailer signature and the second trailer license plate information to the data center. In some embodiments, the data center processor is further configured to: receive the second trailer signature and the second trailer license plate information; and remove the second trailer from the census of trailers located at the location. In some embodiments, the data center processor is further configured to: determine tractor license plate information from a license plate on the truck entering the access point; and determine that the vehicle entering the access point comprises a tractor entering the access point based on one or more of the vehicle signature and the tractor license plate information. In some embodiments, the data center processor is further configured to: determine tractor license plate information from a license plate on the truck exiting the access point; and determine that the vehicle exiting the access point comprises a tractor entering the access point based on one or more of the vehicle signature and the tractor license plate information.

### BRIEF DESCRIPTION OF THE DRAWINGS

For a more complete understanding of the present disclosure and its features and/or advantages, reference is now made to the following description, taken in conjunction with the accompanying drawings, which are not drawn to scale, and in which:

FIG. 1 depicts a system architecture of one embodiment of a network for smart video surveillance;

FIGS. 2-7 depict embodiments of user systems for capturing information from devices associated with user locations;

FIG. 8 is a diagram of an information handling system configurable for processing and storing information from devices associated with user locations;

FIG. 9 is a stock image of an exemplary tractor unit (tractor);

FIGS. 10-11 are stock images of exemplary tractors coupled to exemplary trailers;

FIGS. 12 and 13 are stock images of exemplary box trucks;

FIG. 14 is a stock image of an exemplary delivery van; and

FIG. 15 depicts a flow diagram, illustrating an embodiment of a method for identifying trucks including tractors and trailers.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a reference numeral refers to a class or type of entity, and any letter or hyphenated numeral following such reference numeral refers to a specific instance of a particular entity of that class or type. Thus, for example, a camera referenced by ‘10-1’ may refer to a particular instance of a camera, and the reference ‘10’ may refer to a collection of instances of a camera or any one instance of a camera.

Video monitoring systems may be useful for monitoring a range of environments (e.g., controlled vs uncontrolled), wherein each environment includes one or more locations (e.g., indoors and outdoors, public and private, small and large) for various object types (e.g., persons, animals, objects, vehicles). In any environment, location or object type, there are inevitably variations. Some variations may be small, but other variations may be significant (i.e., anomalies). Embodiments disclosed herein may monitor video frames from camera and identify anomalies.

### System Overview

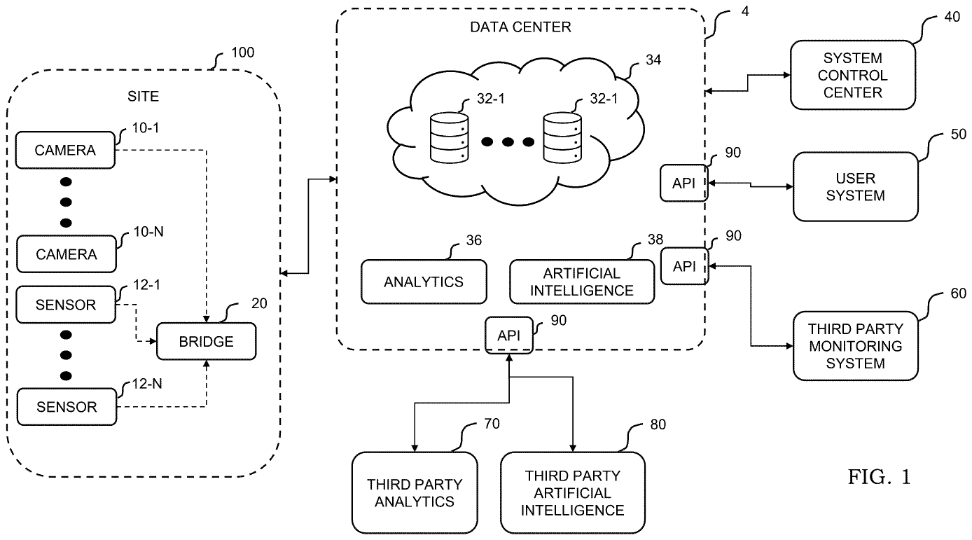

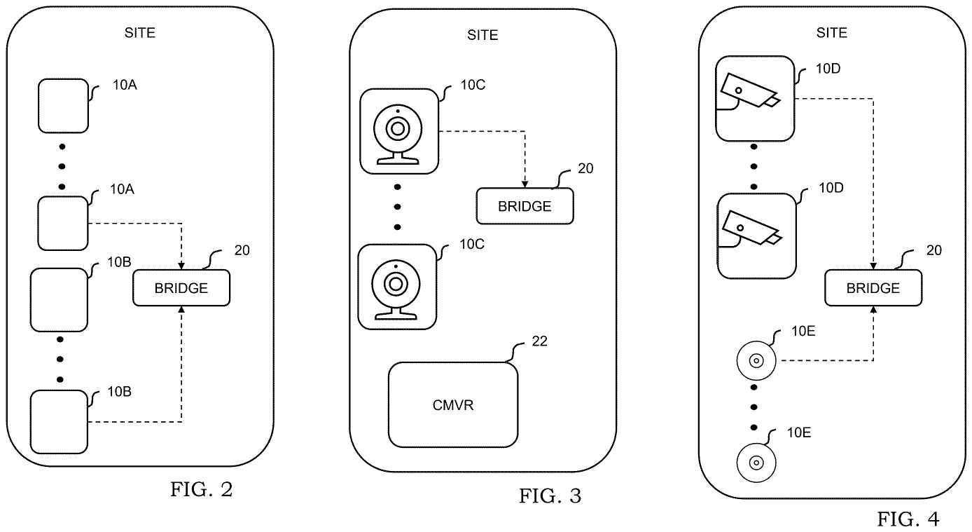

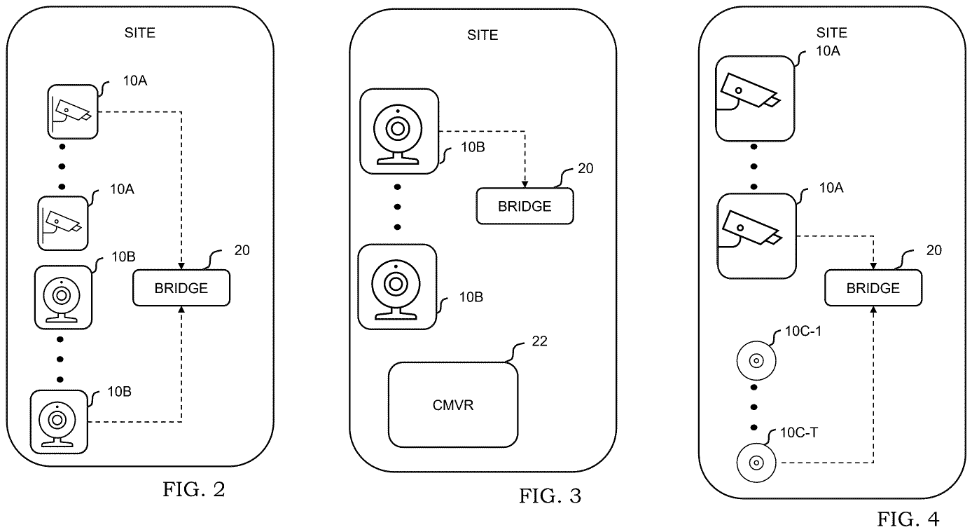

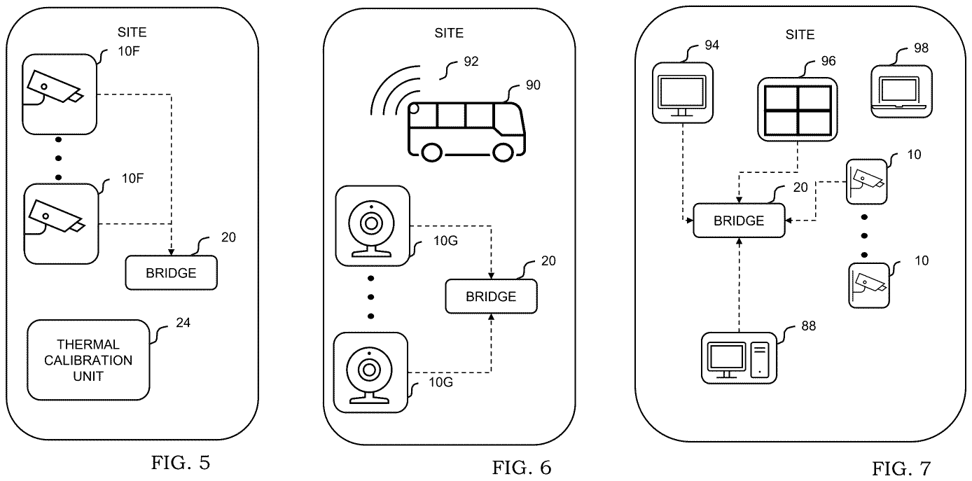

Turning to FIG. 1, a system architecture of embodiments disclosed herein may comprise a plurality of cameras 10 at site 100 communicatively coupled to data center 30. Site 100 may comprise a set of cameras 10 communicatively coupled to bridge 12. Bridge 12 may comprise processor 14 and memory storing a set of instructions and may communicate with display 18 and audio transmitter/receiver 20.

### Cameras

Cameras 10 may comprise analog and/or digital (e.g., Internet Protocol or “IP”) cameras 10 for capturing video streams and other information relating to an environment. Cameras 10 may include, but are not limited to, directional cameras 10, 360-degree cameras 10, fish-eye cameras 10, black-and-white video cameras 10, color cameras 10, high resolution cameras 10, low-resolution cameras 10 and/or infrared cameras 10 for capturing video information. One or more cameras 10 may comprise proprietary cameras 10 associated with Eagle Eye Networks, Inc. of Austin, Texas. In some embodiments, one or more cameras 10 may be manufactured by a third-party enterprise.

At sites 100, cameras 10 may be located inside or outside a structure (e.g., an office building, a school or a warehouse) or near an area (e.g., near elevators or an entrance to a building, near a playground, in a park or in a parking lot). Referring to FIG. 6, in some embodiments, cameras 10 and/or bridge 20 may be located in vehicle 90 with mobile network device 92 configured to communicate with data center 30 over a network (e.g., cellular or Wi-Fi).

Cameras 10 may be selected and positioned to capture video streams and other information. For example, camera 10 may be positioned to capture video streams and other information associated with fire detection, positioned to capture video streams and other information related to any motion, a 360-degree camera 10 selected and positioned near an elevator or in a room to capture video streams and other information relating to movement of people, a directional camera 10 positioned and directed toward a door to capture video streams and other information relating to movement of people through the door or positioned and directed toward a gate to capture i_video streams and other information relating to movement of vehicles through the gate.

### Bridges

Embodiments of bridge 20 may receive information (including single images and video streams comprising a plurality of images) from cameras 10 and communicate images, video streams and other information to data center 30. Information may include, for example, a video stream and may also include a temperature reading, a sound level, and/or information about a specific camera 10 associated with the information. In some embodiments, bridge 20 may receive information from one or more cameras 10 and directly communicate the information to data center 30. In some embodiments, bridge 20 may receive information from one or more cameras 10 and analyze or process at least a portion of the information before communicating the information to data center 30. In some embodiments, bridge 20 may receive information from one or more cameras 10 and store at least a portion of the information before communicating the information to data center 30. Thus, communicatively coupling cameras 10 to bridges 20 and communicatively coupling bridges 20 to data center 30 may refer to directly or indirectly communicating information from cameras 10 to data center 30, communicating information from cameras 10 through bridges 20 to data center 30, and/or analyzing, processing or storing at least a portion of the information before communicating the information to data center 30. Embodiments of bridge 20 may be configured to communicate information to data center 30 in real-time, based on time (e.g., at scheduled intervals or at a scheduled time) or based on an event (e.g., in response to a predefined trigger).

In some embodiments, camera 10 and/or bridge 20 may be configured to perform license plate reading (LPR), wherein a memory in camera 10 and/or bridge 20 may store a set of instructions executable by a processor in camera 10 and/or bridge 20 to capture or receive an image, determine the image depicts a vehicle, identify a license plate on the vehicle, and read (e.g., determine) a set of characters on the license plate. The set of characters may include letters and/or numbers and/or symbols. Camera and/or bridge 20 may communicate the image and the information associated with the image to data center 30 for additional processing.

### Data Center

Embodiments of data center 30 may comprise a plurality of data storage servers 32, wherein data storage servers 32 may be collectively referred to as cloud 34. Data storage servers 32 may store information received from devices 10 and/or bridges 20. In some embodiments, data center 30 may be configured to store information received from a single device 10 of the plurality of devices 10 in at least three separate data storage servers 32 for redundant storage. Data center 30 may comprise analytics server 36 and artificial intelligence (AI) server 38, discussed in greater detail below.

### Data Center Information Processing

Information processing may comprise analyzing information from one or more devices 10. For example, information processing may include determining a manufacturer of device 10, an accuracy of device 10, a minimum threshold (e.g., minimum sound level, illumination or temperature) associated with device 10, a maximum threshold (e.g., maximum temperature, sound level or illumination) associated with device 10, a resolution of camera 10, a frame per second (FPS) processing speed of camera 10, a latency of device 10, a transmission protocol, or some other information associated with the capabilities of device 10 for recording and transmitting information. Device information may also include, for example, information on a location of device 10, wherein location information may include absolute information (e.g., geo-positioning system or GPS information) and/or relative location information (e.g., “the north stairwell”). Device information may include, for example, azimuth or orientation information, wherein orientation information may comprise absolute information (e.g., angled at 45 degrees horizontally and −25 degrees vertically) and/or relative information (e.g., “angled towards the stairwell and looking down”). Device information may include, for example, a time, a date and/or other information to identify where and when information was captured. Device information may include network information, such as an Internet Protocol (IP) address and/or an alias (e.g., “the main lobby camera”).

### Information Handling Systems

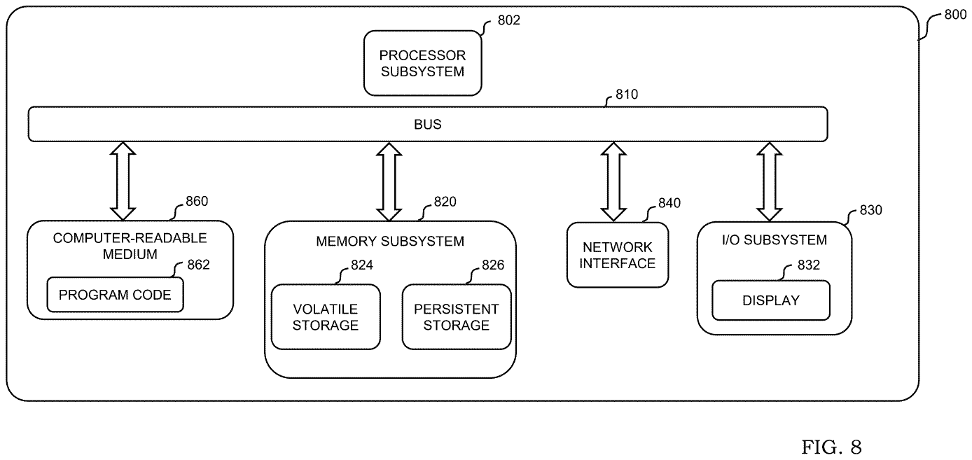

Referring to FIG. 8 and one or more of FIGS. 1, 6 and 7, portions of data center 30, system control center 40, user system 50, third-party systems 60, third-party analytics 70 and third-party artificial intelligence (AI) systems 80 may comprise embodiments of information handling systems 800. FIG. 8 depicts an information handling system 800 capable of administering several of the embodiments of the present disclosure. Information handling system 800 may include processor subsystem 802 communicatively coupled via system bus 810 to memory subsystem 820, input/output (I/O) subsystem 830 and network interface 840.

Processor subsystem 802 may comprise a system, device, or apparatus operable to interpret and execute program instructions and process data, and may include a microprocessor, microcontroller, digital signal processor (DSP), application specific integrated circuit (ASIC), or another digital or analog circuitry configured to interpret and execute program instructions and process data. In some embodiments, processor subsystem 802 may interpret and execute program instructions and process data stored locally (e.g., in memory subsystem 820). In the same or alternative embodiments, processor subsystem 802 may interpret and execute program instructions and process data stored remotely (e.g., in a network storage resource). Processor subsystem 802 may include components such as a central processing unit (GPU) and a graphics processing unit (GPU).

System bus 810 may refer to a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

Memory subsystem 820 may comprise a system, device, or apparatus operable to retain and retrieve program instructions and data for a period of time (e.g., computer-readable media). Memory subsystem 820 may comprise one or more volatile storage 824 and persistent storage 826. Storage may comprise random access memory (RAM), electrically erasable programmable read-only memory (EEPROM), a PCMCIA card, flash memory, magnetic storage, opto-magnetic storage or a suitable selection or array of volatile or non-volatile memory that retains data after power is removed.

I/O subsystem 830 may comprise a system, device, or apparatus generally operable to receive and transmit data to or from or within information handling system 800. I/O subsystem 830 may represent, for example, a variety of communication interfaces, graphics interfaces, video interfaces, user input interfaces, and peripheral interfaces. In various embodiments, I/O subsystem 830 may be used to support various peripheral devices, such as a touch panel, a display adapter, a keyboard, an accelerometer, a touch pad, a gyroscope, or a camera, among other examples. In some implementations, I/O subsystem 830 may support so-called ‘plug and play’ connectivity to external devices, in which the external devices may be added or removed while information handling system 800 is operating. In some embodiments, information handling system 800 may further include display 832. Display 832 may be of a variety of display types, such as a liquid crystal display (LCD), an organic light emitting diode (OLED), a flat panel display, a solid-state display, or a cathode ray tube (CRT). Display 832 may include one or more touch screen display modules and touch screen controllers for receiving user inputs to information handling system 800. Additionally, information handling system 800 may include an input device, such as a keyboard, and a cursor control device, such as a mouse or touchpad or similar peripheral input device.

Network interface 840 may be a suitable system, apparatus, or device operable to serve as an interface between information handling system 800 and a network (not shown). Network interface 840 may enable information handling system 800 to communicate over the network using a suitable transmission protocol or standard. In some embodiments, network interface 840 may be communicatively coupled via the network to a network storage resource (not shown). The network coupled to network interface 840 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and messages (generally referred to as data). The network coupled to network interface 840 may transmit data using a desired storage or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), or any combination thereof. The network coupled to network interface 840 or various components associated therewith may be implemented using hardware, software, or any combination thereof.

Still referring to FIG. 8, computer program product 860 may comprise computer-readable media 870 storing program code 862. Program code 862 may be loaded onto or transferred to information handling system 800 for running by processor subsystem 802.

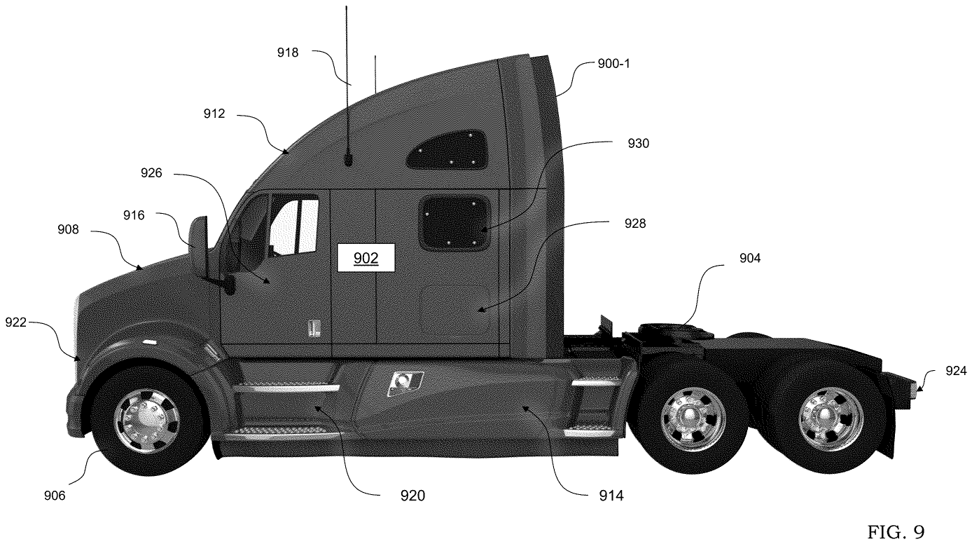

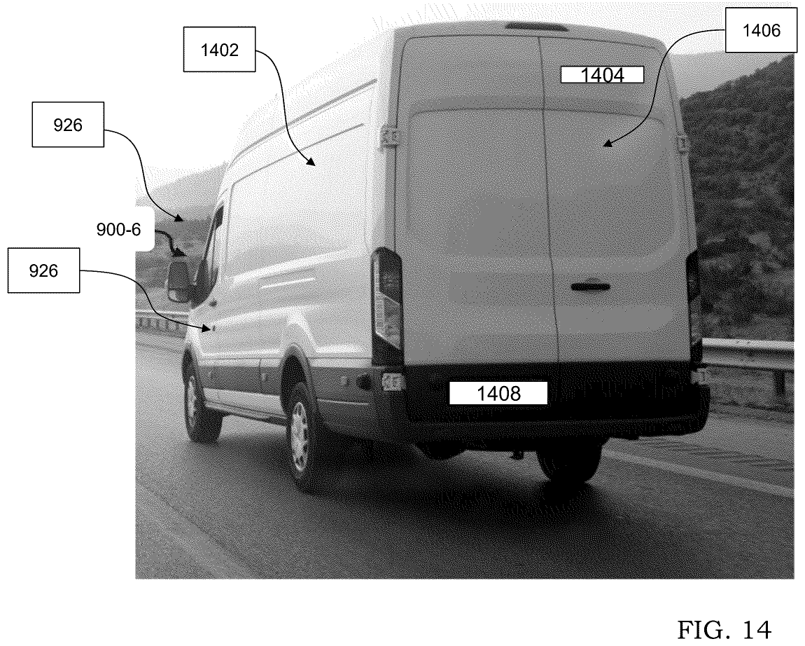

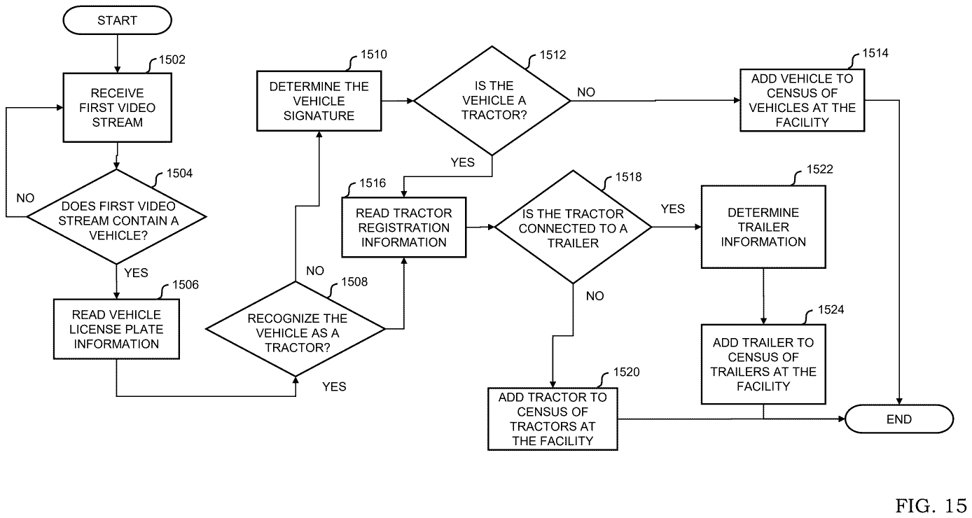

Referring to one or more of FIGS. 9-16, various vehicles may be associated with commercial transportation of cargo, wherein FIGS. 9-13 are commonly referred to as semis, semi-trucks, or 18-wheelers (regardless of the actual number of wheels), FIGS. 14 and 15 are commonly referred to as box trucks, and FIG. 16 is commonly referred to as a delivery truck or delivery van. Per the website for the Federal Motor Carrier Safety Administration, all vehicles 1) used to transport the types and quantities of hazardous materials requiring a safety permit in intrastate commerce; or 2) weighing more than 10,000 pounds; and 3) involved in interstate commerce are required to have a U.S. Department of Transportation (USDOT) registration number. Furthermore, many states require their intrastate commercial motor vehicle registrants to obtain a USDOT Number. Table 1 contains information on USDOT Numbers:

TABLE 1

| | |
|---|---|
| CORRECT | <US DOT 123456 TX> (the letters “US” followed |
| FORMAT | by a space, followed by a unique six-digit number, |
| | followed by a space, then followed by the two-letter |
| | initials of the state in which the vehicle is registered) |
| SIZE | AT LEAST 2 INCHES IN HEIGHT, VISIBLE FROM |
| | AT LEAST 50 FEET |
| | CONTRAST IN COLOR FROM THE |
| | COMMERCIAL VEHICLE |
| LOCATION | BOTH SIDES OF THE VEHICLE |

Notably, the size of the numbers must be at least two inches, but they could be more. However, variations (which may be considered incorrect) exist.

TABLE 2

| | |
|---|---|
| FORMAT VARIATIONS | USDOT123456TX (no spaces) |
| | DOT 123456 (“US” missing) |
| | USDOT #123456 (“#” extra character) |
| | USDOT 123456 (no space between “US” |
| | and “DOT” |

Additionally, regarding the location of a USDOT Number on the side of a vehicle, USDOT Numbers may be located almost anywhere, including on the door or on a cab area behind the door. A USDOT number may be located near other registration numbers. For example, an Operating Authority (“MC”, “FF” or “MX” Number) is required (in addition to a DOT number) for companies that operate as for-hire carriers (for a fee or other compensation) or transport federally regulated commodities or arrange for their transport, in interstate commerce. As other examples, a vehicle identification number (“VIN”), a gross vehicle weight rating (GVWR), or a state number (e.g., “KYU” is a tax license number issued by the state of Kentucky for the Kentucky Weight Distance Tax) may be required. Other information may be located on the side of a vehicle. For example, the name, address and/or phone number of a company, a vehicle identifier for internal use by the company, a slogan, a motto, fire extinguisher information may be displayed on the side of a vehicle. Thus, a vehicle may have one or several numbers or identifiers on a cab door or at other locations on the side of a vehicle.

Referring to FIG. 9, tractors 900 comprise cabin (or “cab”) 902 in front of coupling 904 (also called a fifth wheel) and up to ten wheels 906 on two or three axles. Tractors 900 may be characterized by a shape and features. Most tractors 900 are either “conventional” (in which the engine is forward of the cabin) or “cab over engine” (or COE, in which the cabin is over the engine). FIG. 9 depicts a side view of an exemplary vehicle comprising a conventional tractor 900, wherein tractor 900 includes cabin 902 with an extended sleeper portion. Vehicle 900-1 may sometimes be referred to as a “bobtail” truck because no trailer is attached. Characteristics of tractor 900 as shown may include a sloped hood 908 over the engine compartment, a sloped air dam 912 and fairings 914 covering the fuel tanks for improved aerodynamics. Characteristics of tractor 900 as shown may further include mirrors 916, antennas 918, and steps 920. A license plate may be located on front 922 or rear bumper 924. A USDOT Number or other tractor registration information may be displayed on cab 902, such as cab door 926. Information may also be displayed on a sleeper section (e.g., on door 928). Coupling 904 allows tractor 900 to connect to a trailer (discussed in greater detail below). Tractor 900 may have a vehicle signature characterized by one or more of cabin 902, wheels 906, hood 908 (if present), air dam 912, fairings 914, mirrors 916, antenna 918 and steps 920. For example, a vehicle signature may be characterized by the size and shape of front 922, hood 908, air dam 912 and fairings 914, the appearance of wheels 906 (e.g., chrome, aero cover, etc.), location and number of mirrors 916, antenna 918, steps 920, doors 928 and windows 930.

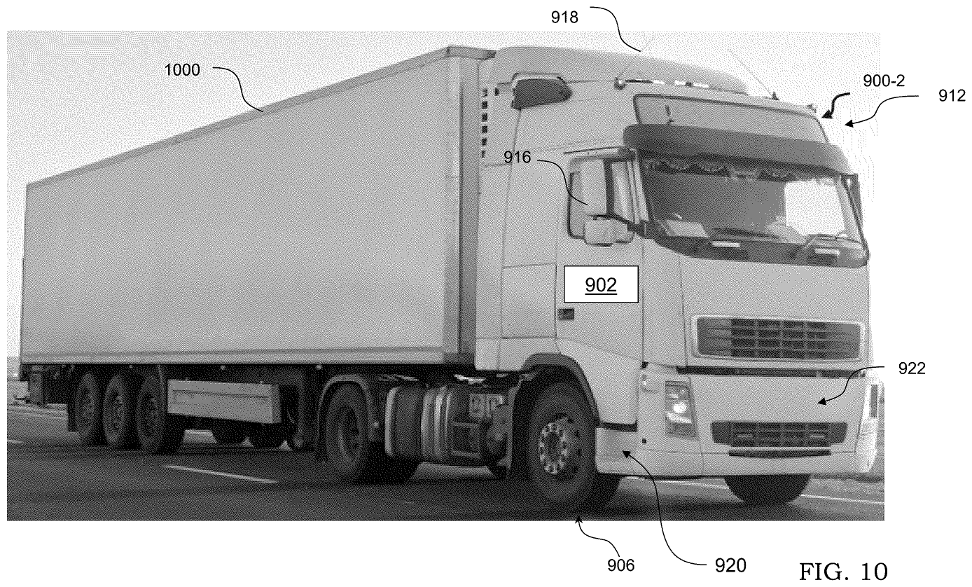

Referring to FIG. 10, a tractor such as tractor 900-2 may be coupled to trailer 1000. Tractor 900-2 depicted in FIG. 10 is a cab over engine (“COE”) design in which cabin 902 is over the engine, such that there is no hood 908, and cabin 902 also lacks a sleeper portion (including doors 928 and windows 930) and air dam 912. Steps 920 may be in front of wheels 906. A license plate (not shown) may be attached to front 922. Antennas 918 may be angled. Unlike tractors 900, trailers 1000 may commonly be the same shape. However, trailers 1000 may vary in the number and position of axles, wheels, text and graphics.

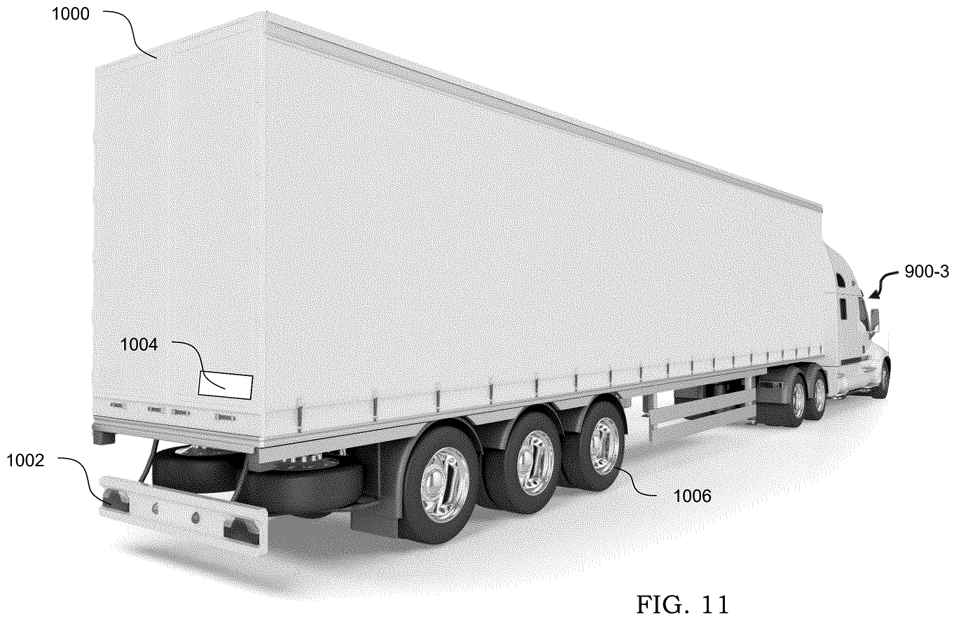

Referring to FIG. 11, a tractor-trailer combination includes tractor 900-3 coupled to trailer 1000. As depicted in FIG. 11, trailer 1000 may include rear bumper 1002 for attaching a trailer license plate (not shown). Trailer 1000 may further include areas 1004 containing trailer information and information such as the name of the trailer manufacturer, a phone number to call for safety concerns and safety messages.

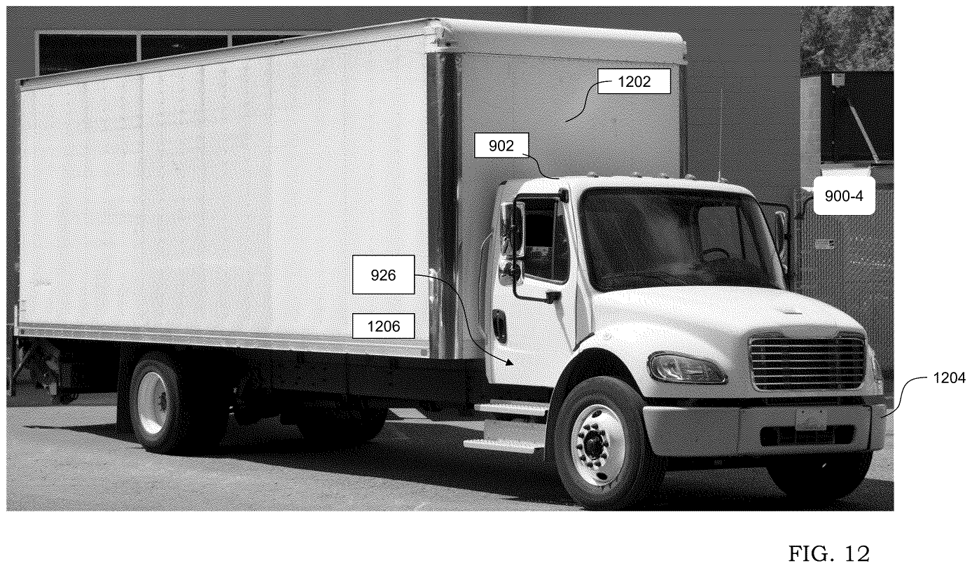

Referring to FIG. 12, vehicle 900-4 may be a box truck, wherein cab 902 and cargo compartment 1202 are connected to a single frame such that cargo compartment 1202 always corresponds to cabin 902. Vehicle information may be displayed on door 926, as well as other places. As depicted in FIG. 12, box truck 900-4 may include front bumper 1204 for attaching a trailer license plate (not shown) and/or other information. Box truck 900-4 may further include areas 1206 containing trailer information and information such as the name of the trailer manufacturer, a phone number to call for safety concerns and safety messages.

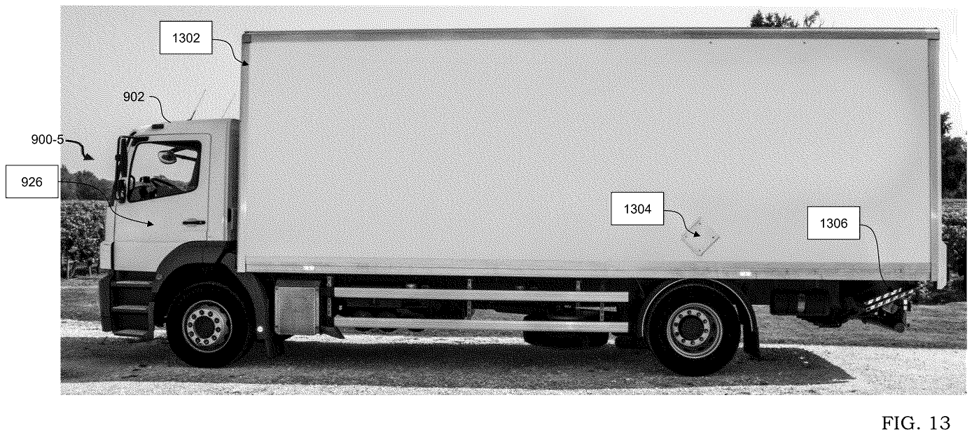

Referring to FIG. 13, vehicle 900-5 may be a box truck, wherein cab 902 and cargo compartment 1302 are connected to a single frame such that cargo compartment 1302 always corresponds to cabin 902. Vehicle information may be displayed on door 926, as well as other places. For example, placard 1304 may be located on a side of cargo compartment 1302, wherein hazardous material (“HAZMAT”) information may be displayed by placard 1304. Note that vehicle 900-5 may have only two axles, with a rear set of wheels comprising four wheels (two on each side). Vehicle 900-5 may also comprise cargo lift 1306 (sometimes referred to as a “tail lift”).

Referring to FIG. 14, vehicle 900-6 may be a delivery van, wherein cab 902 is integrated with cargo compartment 1402 on a single frame such that cargo compartment 1202 always corresponds to cabin 902. Vehicle information may be displayed on door 926, as well as other places. For example, information may be located on an upper portion of rear door 1406 or on bumper 1408. Note that vehicle 900-6 may have only two axles, with a rear set of wheels comprising two wheels (one on each side).

FIG. 15 depicts a flow diagram, illustrating a method for vehicle identification and cargo tracking relative to a location 100.

At step 1502, bridge 20 executes instructions to receive a first video stream containing a first plurality of images corresponding to an access point associated with location 100.

At step 1504, bridge 20 executes instructions to determine if the first video stream contains images of a vehicle 900.

If at step 1504, bridge 20 determines the first video stream does not contain images of a vehicle bridge 20, bridge 20 may repeat steps 1502 and 1504 until a vehicle 900 is detected.

If at step 1504, bridge 20 determines the first video stream contains images of a vehicle 900, then, at step 1506, bridge 20 executes instructions to read a license plate on vehicle 900. License plate reading may or may not be successful, based on lighting, the direction of lighting, the presence of another vehicle 900 passing between vehicle 900 and camera 10, the direction of a camera 10 relative to the vehicle 900, etc.

At step 1508, bridge 20 may analyze the first video stream and/or the license plate information to determine if the vehicle is a tractor 900. For example, bridge 20 executing a set of instructions may determine the first video stream does not provide a clear image of the license plate information, or may determine the license plate information does not correspond to a tractor 900. In this case, at step 1510, bridge 20 may execute instructions to determine a vehicle signature. Determining a vehicle signature may comprise communicating with one or more additional cameras 10 to capture video streams of the vehicle. Each camera 10 may be positioned and oriented to capture a video stream of a vehicle from a particular angle (e.g., a side facing camera 10 may capture a video stream of a side of the vehicle, a top facing camera 10 may capture a video stream of the top of the vehicle, a perspective camera 10 may capture a video stream of the vehicle from a perspective angle.

At step 1512, bridge 20 may execute instructions to determine if the vehicle signature corresponds to a tractor. In some embodiments, determining if the vehicle signature corresponds to a tractor comprises identifying a cabin 902, a fifth wheel connector 904, a plurality of axles and/or wheels 906, a profile of a hood 908, a presence or shape of air dam 912, a presence or shape of fairings 914, a presence or shape of mirrors 916, a location of antennas 918, or some combination.

If, at step 1508, bridge 20 executing a set of instructions determines, from the license plate information, the vehicle 900 comprises a tractor, embodiments may, at step 1516, execute instructions to read tractor registration information. In some embodiments, bridge 20 executes instructions to receive a second video stream containing a second plurality of images of vehicle 900 entering an access point.

At step 1518, embodiments determine if the tractor is connected to a trailer.

If, at step 1518, embodiments determine the tractor is not connected to a trailer, then, at step 1520, embodiments add the tractor to a census of tractors at the facility. Adding the tractor to the census of tractors at the facility may comprise storing information (e.g., license plate information, DOT information, a vehicle signature) to a database of tractors at the facility.

If, at step 1518, embodiments determine the tractor is connected to a trailer, then, at step 1522, embodiments determine trailer information and add the trailer to a census of trailers at the facility. Adding the trailer to the census of trailers at the facility may comprise storing information (e.g., license plate information, DOT information, a trailer signature) to a database of trailers at the facility. In some embodiments, bridge 20 executes instructions to communicate tractor information and/or trailer information to server 32.

When a vehicle leaves the facility, embodiments may perform a similar set of instructions to determine whether a vehicle stream contains a vehicle, read the license plate of the vehicle, read tractor registration information and determine if the tractor is connected to a trailer. If the tractor is not connected to a trailer, embodiments may remove the tractor from the census of tractors at the facility. If the tractor is connected to a trailer, embodiments may determine trailer information and remove the tractor from the census of tractors at the facility and remove the trailer from the census of trailers at the facility.

In some embodiments, video streams from multiple cameras 10 may be communicated to data center 30. Data center 30 may analyze video streams from multiple cameras to determine tractor registration information for the tractor entering the access point from the second video stream, add the tractor to a census of tractors located at the location 100, determine a transportation entity associated with the tractor, and determine a cargo associated with the transportation entity.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for vehicle identification and cargo tracking, the method comprising:
at a bridge associated with a location:
receiving a first video stream containing a first plurality of images of a vehicle entering an access point associated with the location;
determining a vehicle signature for the vehicle entering the access point;
determining that the vehicle entering the access point comprises a tractor entering the access point;
receiving a second video stream, wherein the second video stream contains a second plurality of images of the tractor entering the access point;
determining tractor registration information for the tractor entering the access point from the second video stream; and
communicating the vehicle signature and the tractor registration information for the tractor entering the access point to a data center,
wherein the data center performs:
receiving the vehicle signature and the tractor registration information for the tractor entering the access point;
adding the tractor to a census of tractors located at the location;
determining a transportation entity associated with the tractor; and
determining a cargo associated with the transportation entity.

2. The method of claim 1, wherein the first video stream is received from a first camera oriented to capture the first video stream relative to a front of the vehicle entering the access point.

3. The method of claim 2, wherein the second video stream is received from a second camera oriented to capture the second video stream relative to a side of the tractor entering the access point.

4. The method of claim 3, wherein the second camera is oriented to capture the second video stream relative to a door of the tractor entering the access point.

5. The method of claim 1, wherein the tractor registration information comprises a Department of Transportation (DOT) number.

6. The method of claim 1, further comprising:
at the bridge:
receiving a third video stream containing a plurality of images of the tractor entering the access point;
determining the tractor entering the access point is connected to a trailer;
determining a first trailer signature for the first trailer;
determining first trailer license plate information from a license plate on the first trailer;
communicating the first trailer signature and the first trailer license plate information to the data center,
wherein the data center performs:
receiving the first trailer signature and the first trailer license plate information;
adding the first trailer to a census of trailers located at the location;
determining a cargo entity associated with the first trailer; and
determining a cargo associated with the cargo entity.

7. The method of claim 1, further comprising:
at the bridge:
receiving a fourth video stream containing a plurality of images of a vehicle exiting the access point;
determining a vehicle signature for the vehicle exiting the access point;
determining, based on the vehicle signature, that the vehicle exiting the access point comprises a tractor;
determining tractor registration information for the tractor exiting the access point; and
communicating one or more of the tractor signature and the tractor registration information for the tractor exiting the access point to the data center,
wherein the data center performs:
receiving one or more of the tractor signature and the tractor registration information for the tractor exiting the access point; and
removing the tractor exiting the access point from the census of tractors located at the location.

8. The method of claim 7, further comprising:
at the bridge:
receiving a fifth video stream containing a plurality of images of a second trailer connected to the tractor exiting the access point;
determining a second trailer signature for the second trailer; and
determining second trailer license plate information from a license plate on the second trailer; and
communicating one or more of the second trailer signature and the second trailer license plate information to the data center,
wherein the data center performs:
receiving the second trailer signature and the second trailer license plate information; and
removing the second trailer from the census of trailers located at the location.

9. The method of claim 1, further comprising:
determining tractor license plate information from a license plate on the truck entering the access point, wherein determining that the vehicle entering the access point comprises a tractor entering the access point is based on one or more of the vehicle signature and the tractor license plate information.

10. The method of claim 1, further comprising:
determining tractor license plate information from a license plate on the truck exiting the access point, wherein determining that the vehicle exiting the access point comprises a tractor entering the access point is based on one or more of the vehicle signature and the tractor license plate information.

11. A system for vehicle identification and cargo tracking, the system comprising:
a bridge communicatively coupled to a plurality of cameras associated with a location, wherein the bridge comprises:
a bridge memory storing a set of bridge instructions; and
a bridge processor configured to execute the set of bridge instructions to:
receive a first video stream containing a first plurality of images of a vehicle entering an access point associated with the location;
determine a vehicle signature for the vehicle entering the access point;
determine that the vehicle entering the access point comprises a tractor entering the access point;
receive a second video stream, wherein the second video stream contains a second plurality of images of the tractor entering the access point; and
determine tractor registration information for the tractor entering the access point from the second video stream; and
a data center having a plurality of servers, each server comprising:
a server memory storing a set of server instructions; and
a server processor configured to execute the set of server instructions to:
communicate with the bridge to receive the tractor registration information for the tractor entering the access point, the first video stream and the second video stream;
add the tractor to a census of tractors located at the location;
determine a transportation entity associated with the tractor; and
determine a cargo associated with the transportation entity.

12. The system of claim 11, wherein the first video stream is received from a first camera oriented to capture the first video stream relative to a front of the vehicle entering the access point.

13. The system of claim 12, wherein the second video stream is received from a second camera oriented to capture the second video stream relative to a side of the tractor entering the access point.

14. The system of claim 13, wherein the second camera is oriented to capture the second video stream relative to a door of the tractor entering the access point.

15. The system of claim 11, wherein the tractor registration information comprises a Department of Transportation (DOT) number.

16. The system of claim 11, wherein the bridge processor is further configured to:
receive a third video stream containing a plurality of images of the tractor entering the access point;
determine the tractor entering the access point is connected to a trailer;
determine a first trailer signature for the first trailer;
determine first trailer license plate information from a license plate on the first trailer;
communicate the first trailer signature and the first trailer license plate information to the data center,
wherein the data center processor is further configured to:
receive the first trailer signature and the first trailer license plate information;
add the first trailer to a census of trailers located at the location;
determine a cargo entity associated with the first trailer; and
determine a cargo associated with the cargo entity.

17. The system of claim 11, wherein the bridge processor is further configured to:
receive a fourth video stream containing a plurality of images of a vehicle exiting the access point;
determine a vehicle signature for the vehicle exiting the access point;
determine, based on the vehicle signature, that the vehicle exiting the access point comprises a tractor;
determine tractor registration information for the tractor exiting the access point; and
communicate one or more of the tractor signature and the tractor registration information for the tractor exiting the access point to the data center,
wherein the data center processor is further configured to:
receive one or more of the tractor signature and the tractor registration information for the tractor exiting the access point; and
remove the tractor exiting the access point from the census of tractors located at the location.

18. The system of claim 17, wherein the bridge processor is further configured to:
receive a fifth video stream containing a plurality of images of a second trailer connected to the tractor exiting the access point;
determine a second trailer signature for the second trailer; and
determine second trailer license plate information from a license plate on the second trailer; and
communicate one or more of the second trailer signature and the second trailer license plate information to the data center,
wherein the data center processor is further configured to:
receive the second trailer signature and the second trailer license plate information; and
remove the second trailer from the census of trailers located at the location.

19. The system of claim 1, wherein the data center processor is further configured to:
determine tractor license plate information from a license plate on the truck entering the access point; and
determine that the vehicle entering the access point comprises a tractor entering the access point based on one or more of the vehicle signature and the tractor license plate information.

20. The system of claim 1, wherein the data center processor is further configured to:
determine tractor license plate information from a license plate on the truck exiting the access point; and
determine that the vehicle exiting the access point comprises a tractor entering the access point based on one or more of the vehicle signature and the tractor license plate information.
